(19) United States
(12) Patent Application Publication
(10) Pub. No.: US 2013/0335762 A1
(43) Pub. Date: Dec. 19, 2013

(54) INTEGRATED IMAGING DEVICES

(71) Applicants: Paul Gregory Van Gasse, Tigard, OR (US); Brent Rodney Jones, Sherwood, OR (US); Edward F. Burress, West Linn, OR (US); Michael E. Jones, West Linn, OR (US); Michael C. Gordon, West Linn, OR (US); Steve R. Slotto, Camas, WA (US); Isaac S. Frazier, Portland, OR (US); Aaron L. Boyce, Tigard, OR (US); Trevor James Snyder, Newberg, OR (US)

(72) Inventors: Paul Gregory Van Gasse, Tigard, OR (US); Brent Rodney Jones, Sherwood, OR (US); Edward F. Burress, West Linn, OR (US); Michael E. Jones, West Linn, OR (US); Michael C. Gordon, West Linn, OR (US); Steve R. Slotto, Camas, WA (US); Isaac S. Frazier, Portland, OR (US); Aaron L. Boyce, Tigard, OR (US); Trevor James Snyder, Newberg, OR (US)

(73) Assignee: XEROX CORPORATION, Norwalk, CT (US)

(21) Appl. No.: 13/517,626

(22) Filed: Jun. 14, 2012

(51) Int. Cl. G06K 15/02

(52) U.S. Cl. 358/1.13

(57) ABSTRACT

The present disclosure provides systems and methods for implementing an integrated imaging device. The device includes a scan-bar located along a media path in flow communication with an input tray, and a printing assembly associated with the media path. During a scan operation, the scan-bar scans a medium received along the media path from the input tray while the printing assembly is configured to be non-operational.

### TECHNICAL FIELD

The presently disclosed embodiments relate to multi-function devices and more particularly, to integration of scanning and printing functionalities in a single device.

### BACKGROUND

Multi-function devices incorporate a variety of different functionalities, such as printing, scanning and copying, in a single device. These devices generally include input trays such as an auxiliary media tray and a main media tray, for introducing input media into the multi-function devices. Input trays receive media, for example, in the form of sheets that are routed along a media path comprising components such as shafts, rollers, and diverters to a printing assembly, which transfers images onto the input media.

The multi-function devices may further include an image capturing apparatus, e.g. for copying or scanning a document, comprising a scan-bar or scan-apparatus, which is located below a scan platen, for purposes of scanning or copying input media. A typical modern multi-function device may include a document feeder located above a scanner so that scans are accomplished by traversing a medium over the stationary scan-bar. Media can also be placed stationary on the scan platen. In this case, the scan-bar traverses under a glass media support. The media are required to be held sufficiently flat on the scan platen so that the media remains within the focal range of the scan-bar. Guides and other elements of a scanner assembly are utilized to establish the optimal spacing between the scan-bar and the media image being scanned.

Further, the image capturing apparatus and the scanner document feeder are conventionally mounted over the printing assembly in order to integrate the scanning (or copying) functionality with the printing functionality in multi-function devices. This causes an increase in the overall size and cost of the devices.

Therefore, it would be highly desirable to have a cost effective integration of printing, scanning, and copying functionalities in a single device that is not bulky and ensures a standard quality output.

### SUMMARY

The present disclosure provides an integrated imaging device. In one embodiment, the integrated imaging device includes a scan-bar and a printing assembly. The scan-bar can be located near a proximal and/or a distal end of and along a media path that is employed by the printing assembly for performing the printing operation. During the scan operation, printer media path transport components are utilized to move media having an image across a scan-bar apparatus, while the printing assembly is non-operational. The scan-bar utilizes this media path for receiving and scanning an imaged media sheet from an input tray, as well as for supporting print operations, such as performing checks for print quality control, on printable media. In another embodiment, two scan-bars can be employed along the media path to simultaneously scan both sides of a media sheet. In one implementation, the integrated imaging device can further include a platform and an external scanning tool, which can be detachably mounted over the integrated imaging device.

### BRIEF DESCRIPTION OF THE DRAWINGS

FIG. 1 illustrates an exemplary first embodiment of an integrated imaging device.

FIG. 2 illustrates an exemplary second embodiment of the integrated imaging device.

FIG. 3 illustrates an exemplary third embodiment of the integrated imaging device.

FIG. 4A illustrates a scanning tool integrated with the exemplary integrated imaging device of FIG. 1, FIG. 2, or FIG. 3.

FIG. 4B illustrates a foldable platform integrated with the exemplary integrated imaging device of FIG. 1, FIG. 2, or FIG. 3.

FIG. 5 illustrates an exemplary method of implementing the integrated imaging devices.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Overview

According to aspects of the disclosure illustrated herein, an integrated imaging device is described. In one embodiment, the integrated imaging device includes a scan-bar that is located along a media path such that the scan-bar shares at least part of the media path with a printing assembly. The media path includes transport components such as shafts, rollers, and diverters arranged in flow communication with an input tray such as a main media tray or an auxiliary media tray, which provides media to the integrated imaging device. During a scan operation, the printing assembly is configured to be non operational except for at least some of the printer media transport components of the media path, which is then used to feed the scan-bar for scanning scan media. As a result, there is no requirement for separate scan or copy hardware to provide the scan media to the scan-bar for scanning, thereby reducing the cost and size of the integrated imaging device.

### Exemplary Embodiments

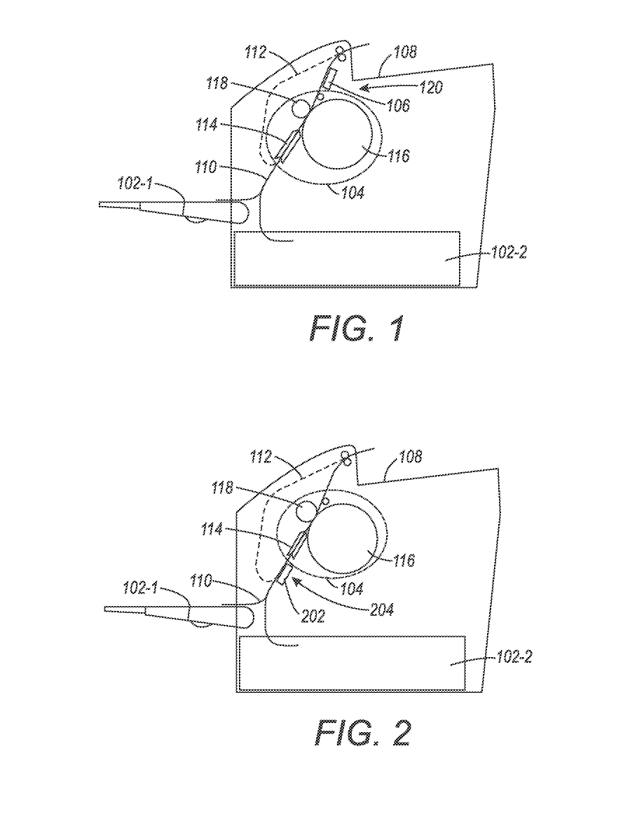

FIG. 1 illustrates pertinent modules of an exemplary first embodiment of an integrated imaging device. In one embodiment, the integrated imaging device 100 may be an offset type imaging device including input trays, such as an auxiliary media tray 102-1 and a main media tray 102-2, hereinafter collectively referred to as input trays 102; however it should be understood that some models of the device 100 may accept multiple such trays and/or high capacity units. The integrated imaging device 100 further includes a printing assembly 104, a scan-bar 106, and an output section or tray 108. The input trays 102 facilitate introduction of input media, typically “blank”, into the integrated imaging device 100. The terms “media”, “medium”, “input media”, “input medium” and “medium sheet” refer to physical sheets of paper, plastic, cardboard, or other suitable physical substrates that can pass through a media path such as a first media path 110 or a second media path 112 inside the integrated imaging device 100. For ease of reference the media that is printed will be referred to as print media, while media that is scanned will be referred to as scan media. The term “media path” refers to the route followed by the media inside the integrated imaging device 100. The media path can include components such as shafts, rollers, guides, and diverters for transporting the input media inside the imaging device 100. The input media can be stacked at the input trays 102 and fetched singularly or sequentially by a pick and feed assembly (not shown in the figure). The fetched input media can be guided onto a media path such as the first media path 110 inside the integrated imaging device 100. The term “scan-bar” encompasses various scan apparatus configurations appropriate for copy and scan functions.

The printing assembly 104 transfers a desired image on to the print media. The printing assembly 104 can accommodate different configurations of a variety of components that are well known in the art for first imaging an offset surface and then image transfer and fixation on the print media. In one implementation, the printing assembly 104 includes a media heating assembly, which may include various elements, for example, a radiant heater 114 that radiates heat onto the print medium.

Typically, a printing transfer operation is performed in two steps, namely, heating of the print medium and image fixation on the heated print medium. The input medium is heated by a heater such as the radiant heater 114 to allow ink to fuse into the print medium. It is to be understood that the heating of the media at an appropriate temperature pertaining to the ink type is known in the art. The heated print medium then follows a media path such as the first media path 110 to the image transfer components, which may include a variety of components for performing image fixation on the heated print medium. For example, a solid ink printer includes an imaging drum 116 and a transfix roller 118. In this example of printing technology, solid ink in a molten state is jetted onto the drum 116 to form an image which is then transferred to the media passing through a nip formed at the interface between the drum 116 and transfix roller 118. The ink droplets, called pixels, are flattened by the transfix roller 118, through heat and pressure on the print medium for permanently securing the desired image on the print medium.

In the above embodiment, the integrated imaging device 100 includes the scan-bar 106 to perform scanning of scan media, for example, documents, printed photos, posters, etc. The integrated imaging device 100 is adapted to integrate the scan-bar 106 along the media path, for example, the first media path 110, near the distal end 120 of the media path such as the first media path 110. The distal end 120 of the first media path 110 can be defined as the end that is near to the output tray 108 of the integrated imaging device 100.

The scan-bar 106 can be integrated using a variety of techniques and components known in the art. In a first implementation, the scan-bar 106 can be rigidly mounted on a bar or a panel (not shown in the figure) fixed inside the integrated imaging device 100 to position the scan-bar 106 along the first media path 110. In a second implementation, the scan-bar 106 can be pivotally mounted on a bar or a panel (not shown in the figure) along the first media path 110 such that the scan-bar 106 can be configured to orient in different directions. For example, in one orientation, the scan-bar 106 can be configured to align with an offset imaging surface, such as the drum 116, to identify print errors, such as unintended voids, vertical banding, and color mismatch, for image quality during the printing operation. In another orientation, the scan-bar 106 can be configured to align with the first media path 110 to perform scanning of the scan media passing along the first media path 110. In a third implementation, the scan-bar 106 can be movably mounted laterally relative to the first media path 110. Scanning both sides of the media can be accomplished by routing the media through the media reversal (duplex) path, such as the second media path 112, so that the opposite side of scan media then faces the scan-bar 106. Alternatively, dual scan-bars may be employed, directly opposing one another or placed at different locations (as is discussed in greater detail below).

Such placement of the scan-bar 106 facilitates scanning of the scan media by using at least part of the media path that is used by the printing assembly 104, which is operatively deactivated during a scan operation. Thus the scan media path shares components of the print media path, for example, the first media path 110, which may have additional scan related media position or constraining members. Therefore, separate scan/copy hardware, such as a scan platen, is not required for performing the scan operation, thereby reducing the cost and size of the integrated imaging device 100. It is to be noted that different types of scan-bars based on resolution, size and technology are well known in the art and can be used for implementation with respect to the present disclosure.

After the scanning operation is complete, the scanned media are outputted to the output tray 108, for example, along a first media path 110. The output tray 108 may be a simple collection bin or may have one or more bins with or without additional “finisher” functions, for example, stapling or collating print media after the print operation and scan media after the scan operation. The scan media can also be reversed in direction before exiting from the imaging device 100 and can be guided to follow the second media path 112 for duplex scanning of the scan media. The scan media is reversed and fed to the first media path 110 via the second media path 112 to perform a scan operation on the reversed side of the scan media. In some implementations, the media side that faces up in an output tray 108 may be of significance and may also be selectable through options available to the user. In these cases a single-sided media scan may pass through once en route, such as through the first media path 110, to the output tray 108 or may be reversed to flip sides before progressing to the output tray 108. The same consideration could be applied to a duplex scan of the media but the user's choice of initial side up would nominally determine the media side up in the output tray 108. Orientation of the image to be scanned is dependent on the location of the scan-bar 106 relative to the side of the media path, such as the first media path 110. It will be appreciated to understand that this location may vary in different multi-function devices, due for example, to space available for scan-bar placement.

FIG. 2 illustrates an exemplary second embodiment of an integrated imaging device. The same numbers, as mentioned in FIG. 1, are used throughout FIG. 2 to reference like features and components. The components include the input trays 102, the printing assembly 104, and the output tray 108, which individually operate in a manner as described with respect to FIG. 1. In the second embodiment, the integrated imaging device 100 can be adapted to integrate the scan-bar 202 along the first media path 110 near the proximal end 204 of the media path, such as the first media path 110. The proximal end 204 of the first media path 110 can be defined as the end that is near to the input trays 102 of the integrated imaging device 100. The scan-bar 202 placed at such a location would be near the media input, such as the input trays 102 but after the duplex turn around entry, which is typically near the media input, merging into the first media path 110.

In a first exemplary application, the scan-bar 202 can be configured to read pre-printed QR codes, bar codes, text headers, or similar indicators for automated work-flow tasks and to set default actions at the output of a scan operation. It should be understood that such functionality is a combination of scan-bar hardware, its controller and firmware and/or software. Examples of default actions include, but are not limited to, sending an electronic copy of the scan media or the print media to a fax machine, email, etc., setting media imaging and handling actions, for example, adding a header to the image, etc., and identifying, securely erasing, and storing classified information. In a second exemplary application, the scan-bar 202 can be configured to detect damaged media and pre-punched media prior to the scan or print operation. In a third exemplary application, the scan-bar 202 can determine the media size for auto-scaling or rotation of a desired image to fit the media in order to perform a print operation without user intervention. Further, the scan-bar 202 placed at this location can detect staples present in the input medium before the medium is processed for printing or scanning Such detection of staples allows steps to be taken to avoid damage to the imaging drum 116 during the print operation and can save repair cost, labor time, and device down time. The scan-bar 202 can be implemented in manners similar to, but are not limited to, those discussed in the description of FIG. 1.

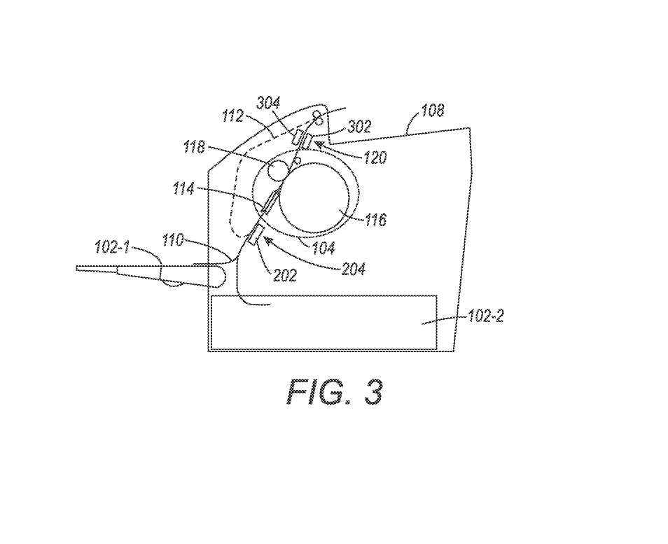

FIG. 3 illustrates an exemplary third embodiment of an integrated imaging device. The same numbers are used throughout FIG. 3 to reference like features and components including the input trays 102, the printing assembly 104, and the output tray 108 discussed with respect to FIG. 1 and the scan-bar 202 discussed with respect to FIG. 2. In a third embodiment, the integrated imaging device 100 can be adapted to integrate a first scan-bar 302 and a second scan-bar 304, both located along a media path, for example, the first media path 110, and directly opposing each other. Further, the two scan-bars 302 and 304 can be located near the distal end 120 of the first media path 110 and in an example embodiment, ahead of the duplex path such as the second media path 112. It will be understood by those skilled in the art that the scan-bars, such as the scan bars 106, 202, 302, 304, may be placed intermediate to the input trays 102 and the output tray 108.

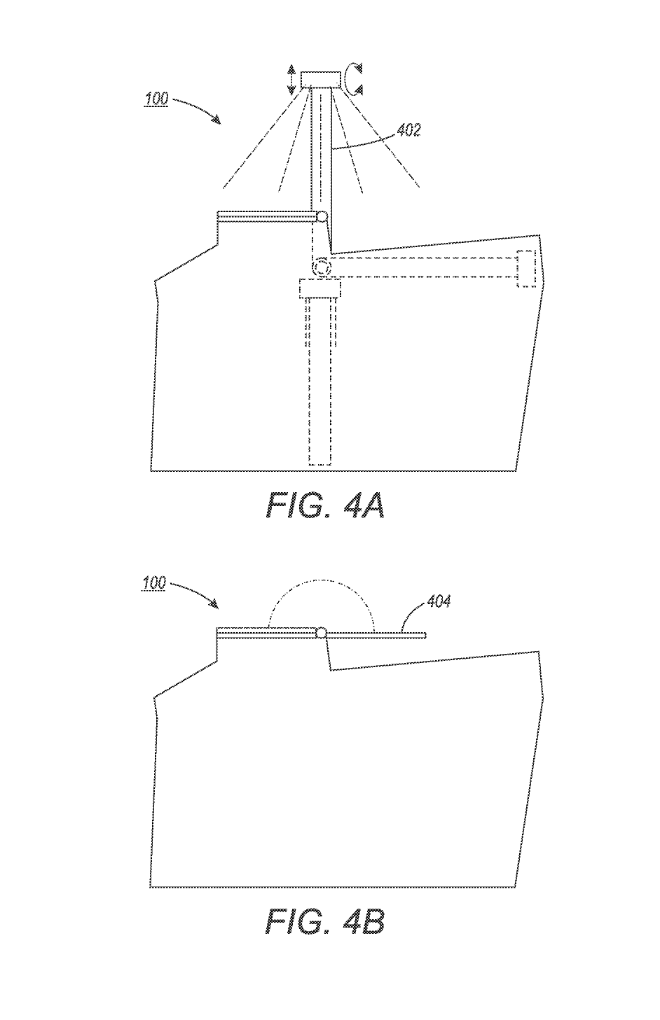

Further, the integrated imaging device 100 may include components to facilitate scanning of an object, for example, a book, a box, etc. that is not capable of passing through a media path located inside the imaging device 100. In one embodiment, the integrated imaging device 100 can include a more typical scanner assembly with a platen and movable scan-bar (not shown) located below the platen. In another embodiment, as shown in FIG. 4A, an external scanning tool 402 can be attached to facilitate scanning of such objects. The scanning tool 402 can be rigidly mounted, adjustable or can be detachable for manual use. Referring to FIG. 4B, a platform 404 can be detachably or rigidly or pivotally mounted to at least a portion of the imaging device 100 to provide a reliable surface for performing the scan operation. When the platform 404 is rigidly or pivotally mounted to the integrated imaging device 100, the platform 404 can be manufactured to be foldable so that the platform 404 occupies less space.

In yet another embodiment, the external scanning tool 402 can be rigidly or pivotally mounted to the integrated imaging device 100 on a structure that extends to enable variable distance from a platform such as the platform 404, or retracts for aesthetics, shipping or product placement considerations. In yet another embodiment, the external scanning tool 402 can be detachably mounted over the rest of the integrated imaging device 100 such that it may function as a mounted unit or may be positioned by manual manipulation. In one example, the detachably mounted scanning tool 402 can be tethered to the rest of the imaging device 100 with a cable. In another example, the scanning tool 402 can be physically disconnected from the rest of the imaging device 100 such that the scanning tool 402 wirelessly communicates with the integrated imaging device 100.

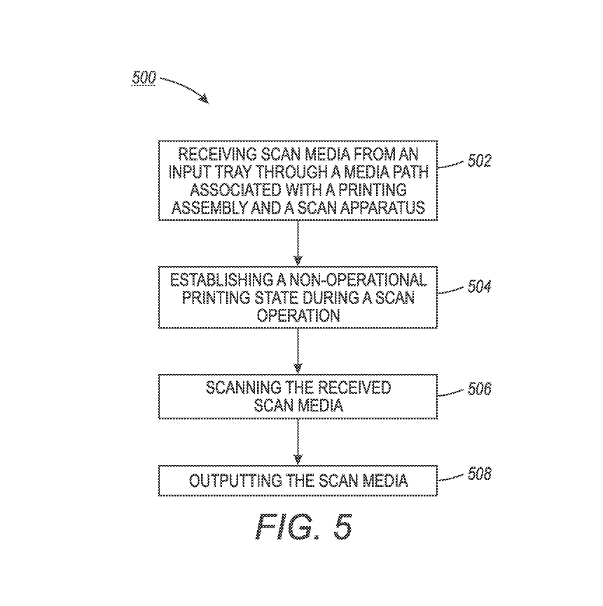

FIG. 5 illustrates an exemplary method for implementing the integrated imaging device 100. The exemplary method is described in the general context of computer executable instructions. Generally, computer executable instructions can include routines, programs, objects, components, data structures, procedures, modules, functions and the like that perform particular functions or implement particular abstract data types. The computer executable instructions can be stored on a computer readable medium and can be loaded or embedded in an appropriate device for execution.

The order in which the method is described is not intended to be construed as a limitation, and any number of the described method blocks can be combined in any order to implement the method, or an alternative method. Additionally, individual blocks may be deleted from the method without departing from the spirit and scope of the present disclosure described herein. Furthermore, the method can be implemented in any suitable hardware, software, firmware, or combination thereof.

At block 502, receiving scan media through a media path associated with a printing assembly and a scan-bar. In one implementation, the scan media can be stacked and placed at the input trays 102 of the integrated imaging device 100. For example, a stack of documents can be placed in the auxiliary media tray 102-1. At the user interface of the integrated imaging device 100, when a user selects the scan option, the scan media is singularly or sequentially pulled into the integrated imaging device 100 through a pick and feed assembly, which feeds the scan media to the media path, for example, the first media path 110, which is associated with the printing assembly 104 and a scan-bar such as the scan-bar 106. The scan bar 106 may be located intermediate to the input trays 102 and the output trays 108.

At block 504, establishing a non-operational printing state that enables the media path to be used for a scan operation. Some steps of a printing process may overlap steps of the scan operation when practical, for example, picking and staging media or routing media to an output tray, such as the output tray 108, therefore causing suspension of print related functions such as image creation and transfer on the media. In accordance with the disclosure, the media path, such as the first media path 110, is shared for both the printing function and the scanning function. During the scan operation, the printing assembly 104 is inoperative but can be configured to move components to a scan-function compatible position, such as moving the transfix roller 118 away from the drum 116.

At block 506, the scan medium is scanned. The scan medium, for example, a previously printed document, is fed and guided along a media path such as the first media path 110 for performing the scanning operation. In one embodiment, the scan media is scanned by a scan-bar, such as the scan-bar 202, which is located along the first media path 110 near the proximal end 204 of the printing assembly 104. The scan-bar 202 positioned at this location can be configured for a variety of applications. Examples of these applications include, but are not limited to, detection of media characteristics such as media width, location and type of media as well as media edges, media size, pre-printed codes, etc.

In another embodiment, the scan media is scanned by a scan-bar, such as the scan-bar 106, which is located along the first media path 110 near the distal end 120 of the printing assembly 104. At this location, the scan-bar 106 can be configured to perform a scan operation for any scan media, for example, a physical document driven along the first media path 110.

In yet another embodiment, a scan medium can be scanned on both sides simultaneously by different scan-bars such as the first and the second scan-bars 302 and 304 respectively, located on opposite sides of the media path such as the first media path 110. Note that these scan-bars need not be directly opposed to one another and may even be positioned distant from one another for product configuration and functional reasons.

Further, in different implementations, the scan-bar, 106, 202, 302 or 304, can be rigidly or pivotally or movably mounted along the first media path 110. All scan-bars can be used for scanning one side or both sides of the scan media by routing the scan media through the duplex path, such as the second media path 112, as would be typical in a single scan-bar configuration. The scan-bar, 106, 202, 302 or 304, can be mounted using a variety of mechanisms, components, or techniques already known in the art. Therefore, during the scan operation, the scan-bar, 106, 202, 302 or 304, utilizes the same media path, which is also used by the printing assembly 104, to perform scanning of the scan media without the use of separate hardware for receiving the scan media to be scanned. It will be understood by a person skilled in the art that the scan media can be scanned in any other media path or media path portion, for example, the second media path 112 that is used by the printing assembly 104 for duplex media routing.

At block 508, the scan media is outputted from the media path. In one implementation, the scan medium follows the first media path 110 for scanning by the scan-bar, 106, 202, 302, and/or 304, which is located along the first media path 110. The scan-bar, 106, 202, 302, and/or 304, may scan only one side or both sides of the scan media passing along the first media path 110 depending upon the implementation of the scan-bar 106 as described above. When duplex scanning with a single scan-bar, the scan media may be rolled back in a direction reversal before exiting from the imaging device 100 and guided to the second media path 112 for scanning the second side of the scan media. The rolled back scan media is again fed to the first media path 110 via the second media path 112, which reverses the scan media and enables scanning of the other side of the scan media in the first media path 110. Scan media is then outputted to the output tray 108 for retrieval of the scan media.

The scan-bars 106, 202, 302 or 304 can be associated with any known imaging device capable of integrating different functionalities such as printing, copying and scanning The locations of the scan-bars 106, 202, 302 or 304 discussed in the present disclosure help to reduce size, mass, and cost of a multi-function device such as an integrated imaging device 100. Scan-bar placement considerations can be significantly influenced by available space within an imaging device. Benefits of the present concept extend to alternative scan-bar placement, for example, being ahead of the duplex path entry into the media path, such as the first media path 110. In this type of implementation, scanning both sides of a document can be accomplished by placing scan media in an appropriate input tray, such as the auxiliary media tray 102-1 or the main media tray 102-2, for the first scan pass and then manually flipping sides and placing it in the input tray for the second side scan.

Although the integrated imaging device 100 has been explained with respect to integration of printing, scanning and copying functionalities, it will be well understood by a person skilled in the art that other functionalities, such as facsimile, sending of email and network communication with other printers, can also be incorporated in the device.

It should be noted that the description above does not set out specific details of manufacture or design of the various components. Those of skill in the art are familiar with such details, and unless departures from those techniques are set out, techniques, designs and materials known in the art should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the invention as encompassed by the following claims.

What is claimed is:

1. An integrated imaging device comprising:
at least one scan-bar located along a media path in flow communication with at least one input tray; and
a printing assembly associated with the media path, wherein the at least one scan-bar scans a medium received along the media path during a scan operation, while the printing assembly is configured to be non-operational.

2. The integrated imaging device of claim 1, wherein the at least one scan-bar is located intermediate to the at least one input tray and an output tray.

3. The integrated imaging device of claim 2, wherein the at least one scan-bar is located along the media path near at least one of a proximal and a distal end of the printing assembly.

4. The integrated imaging device of claim 1, further comprising a platform and a scanning tool, wherein at least one of the platform and scanning tool is pivotally or detachably mounted to the integrated imaging device.

5. The integrated imaging device of claim 4, wherein the scanning tool wirelessly communicates with the rest of the integrated imaging device.

6. The integrated imaging device of claim 4, wherein the platform is foldable.

7. A system comprising:
a printing assembly associated with a media path for performing a print operation, wherein the media path is in flow communication with at least one input tray; and
at least one scan-bar utilizing the media path for performing a scan operation.

8. The system of claim 7, wherein the printing assembly is configured to be non-operational when the media path being utilized by the at least one scan-bar to scan a medium during the scan operation.

9. The system of claim 7, wherein the at least one scan-bar is located along the media path and intermediate to the at least one input tray and an output tray.

10. The system of claim 9, wherein the at least one scan-bar is located near at least one of a proximal and a distal end of the media path.

11. The system of claim 7 further comprising a platform and a scanning tool, wherein at least one of which is detachably mounted to the integrated imaging device.

12. The system of claim 11, wherein the platform is foldable.

13. The system of claim 11, wherein the scanning tool wirelessly communicates with the rest of the system.

14. The system of claim 7, wherein the media path includes multiple media paths.

15. A method of scanning a scan medium, comprising:
receiving the scan medium from at least one input tray through a first media path that is at least partially shared for both printing and scan operations;
suspending the printing operation during the scan operation;
scanning the received scan media; and
outputting the scan medium after performing the scan operation.

16. The method of claim 15, wherein the scan medium is scanned by at least one scan-bar located along the first media path and intermediate to the at least one input tray and an output tray.

17. The method of claim 15, wherein the scan medium is rolled back before outputting and guided to follow a second media path for reversing the scan media, which is then fed to the first media path.
